(19) United States
(12) Patent Application Publication
(10) Pub. No.: US 2023/0231259 A1
(43) Pub. Date: Jul. 20, 2023

(54) BATTERY WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kotaro TAKADA, Mie (JP); Osamu NAKAYAMA, Mie (JP); Naoki FUKUSHIMA, Mie (JP); Shuya IKEDA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/011,278

(22) PCT Filed: Jun. 22, 2021
(86) PCT No.: PCT/JP2021/023602

§ 371 Date: Dec. 19, 2022

(30) Foreign Application Priority Data
Jul. 9, 2020 (JP) 2020-118490

(51) Int. Cl. H01M 50/298; H01M 50/507; H01M 50/519; H01M 50/284; H01M 50/516

(52) U.S. Cl. CPC H01M 50/298; H01M 50/507; H01M 50/519; H01M 50/284; H01M 50/516; H01M 2200/10

(57) ABSTRACT

A battery wiring module is to be attached to multiple battery cells being long in a front-rear direction and including electrode leads at front ends and rear ends of the multiple battery cells to electrically connect the multiple battery cells. The battery wiring module includes a first busbar module to be attached to a front section of the multiple battery cells and a second busbar module that is a separate component from the first busbar module and to be attached to a rear section of the multiple battery cells. The first busbar module includes first busbars that are to be connected to the electrode leads protruding frontward from the multiple battery cells, a first flexible printed circuit board that is to be connected to the first busbars, and a first protector that holds the first busbars and the first flexible printed circuit board.

### TECHNICAL FIELD

The present disclosure relates to a battery wiring module.

### BACKGROUND ART

A high-voltage battery pack that is used in an electric automobile or a hybrid automobile normally includes battery cells that are disposed on top of each other and are electrically connected in series or in parallel to each other with a battery wiring module. A battery wiring module that is disclosed in Japanese Translation of PCT International Application Publication No. 2019-511810 (Patent Document 1 described below) has been known as an example of such a battery wiring module. The battery module described in Patent Document 1 includes battery cells and a busbar unit. The battery cells include electrode leads, respectively, protruding in a front-rear direction of the battery module. The busbar unit is configured to integrally connect the electrode leads of the battery cells. The busbar unit includes a first busbar that is connected to the electrode leads protruding frontward, a second busbar that is connected to the electrode leads protruding rearward, and a sensing busbar that electrically connects the first busbar and the second busbar and is integrally mounted on each of the first busbar and the second busbar.

### PRIOR ART

### Patent Document

Patent Document 1: Japanese Translation of PCT

International Application Publication No. 2019-511810

### SUMMARY OF THE INVENTION

### Problem to be Solved by the Invention

According to the configuration of the above-described busbar unit, the first busbar that is disposed in front of the battery cells, the second busbar that is disposed behind the battery cells, and the sensing busbar are integrally provided. Therefore, if the sensing busbar is quite long, handling of the busbar unit is not good and workability in an assembling process of mounting the busbar unit on the battery cells may be decreased. Particularly, as a power storage capacity of the battery cell increases, the battery cell tends to increase in size and this increases the length of the sensing busbar. This may highly decrease the workability in the assembling process.

The technology described herein was made in view of the above circumstances. An object is to provide a battery wiring module that can improve workability in the assembling process.

### Means for Solving the Problem

A battery wiring module according to the present disclosure is long in a front-rear direction and to be attached to multiple battery cells including electrode leads at front ends and rear ends of the multiple battery cells to electrically connect the multiple battery cells. The battery wiring module includes a first busbar module to be attached to a front section of the multiple battery cells and a second busbar module that is a separate component from the first busbar module and to be attached to a rear section of the multiple battery cells. The first busbar module includes first busbars that are to be connected to the electrode leads protruding frontward from the multiple battery cells, a first flexible printed circuit board that is to be connected to the first busbars, and a first protector that holds the first busbars and the first flexible printed circuit board. The second busbar module includes second busbars that are to be connected to the electrode leads protruding rearward from the multiple battery cells, a second flexible printed circuit board that is connected to the second busbars, and a second protector that holds the second busbars and the second flexible printed circuit board. The first flexible printed circuit board and the second flexible printed circuit board are electrically connectable to each other with the first busbar module and the second busbar module being attached to the multiple battery cells.

### Effects of Invention

According to the present disclosure, a battery wiring module that can improve workability in the assembling process can be provided.

### BRIEF DESCRIPTION OF THE DRAWINGS

FIG. 1 is a perspective view of a battery module according to a first embodiment.

FIG. 2 is an exploded perspective view of the battery module.

FIG. 3 is a front view of the battery module.

FIG. 4 is a rear view of the battery module.

FIG. 5 is an enlarged plan view illustrating the battery module including a thermistor circuit.

FIG. 6 is a perspective view of a first busbar module.

FIG. 7 is a perspective view of a second busbar module.

FIG. 8 is a magnified front view illustrating a portion of the battery module adjacent to an external output connector.

FIG. 9 is a magnified perspective view illustrating a connection portion of the first bus bar with a side surface of the connection portion being connected to a first land with soldering.

FIG. 10 is a magnified perspective view illustrating the connection portion of the first bas bar with four side surfaces of the connection portion being connected to the first land with soldering.

FIG. 11 is a perspective view of a battery module according to a second embodiment.

FIG. 12 is an exploded perspective view of the battery module.

### MODES FOR CARRYING OUT THE INVENTION

### Description of Embodiments According to the Present Disclosure

First, embodiments according to the present disclosure will be listed and described.

(1) A battery wiring module according to the present disclosure is to be attached to multiple battery cells being long in a front-rear direction and including electrode leads at front ends and rear ends of the multiple battery cells to electrically connect the multiple battery cells. The battery wiring module includes a first busbar module to be attached to a front section of the multiple battery cells and a second busbar module that is a separate component from the first busbar module and to be attached to a rear section of the multiple battery cells. The first busbar module includes first busbars that are to be connected to the electrode leads protruding frontward from the multiple battery cells, a first flexible printed circuit board that is to be connected to the first busbars, and a first protector that holds the first busbars and the first flexible printed circuit board. The second busbar module includes second busbars that are to be connected to the electrode leads protruding rearward from the multiple battery cells, a second flexible printed circuit board that is connected to the second busbars, and a second protector that holds the second busbars and the second flexible printed circuit board. The first flexible printed circuit board and the second flexible printed circuit board are electrically connectable to each other with the first busbar module and the second busbar module being attached to the multiple battery cells.

According to such a configuration, since the first busbar module and the second busbar module are separate components, the first busbar module and the second busbar module can be attached to the multiple battery cells separately. This improves workability in the assembling process of the battery wiring module.

(2) the first flexible printed circuit board may include a first connector and the second flexible printed circuit board may include a second connector that is fitted to the first connector to electrically connect the first flexible printed circuit board and the second flexible printed circuit board.

According to such a configuration, by fitting the first connector to the second connector after attaching the first busbar module and the second busbar module separately to the multiple battery cells, the first busbar module and the second busbar module are electrically connected to each other.

(3) The first flexible printed circuit board may further include an external output connector. The second connector may be disposed on the second protector and the external output connector may be disposed on the first protector.

According to such a configuration, with the external output connector being disposed on the first protector and the second connector being disposed on the second protector, a space for the battery wiring module can be saved.

(4) The battery wiring module may further include an intermediate line that electrically connects the first flexible printed circuit board and the second flexible printed circuit board. The first flexible printed circuit board may include a first connector. The second flexible printed circuit board may include a second connector. The intermediate line may include a third connector that is fitted to the first connector and a fourth connector that is fitted to the second connector.

According to such a configuration, the intermediate line is provided to electrically connect the first busbar module and the second busbar module. This reduces lengths of the first flexible printed circuit board and the second flexible printed circuit board and improves handling of the first busbar module and the second busbar module.

(5) A thermistor circuit may be integrally disposed on the first flexible printed circuit board and the thermistor circuit may be electrically connected to the external output connector.

According to such a configuration, with the thermistor circuit, the temperature of the multiple battery cells can be detected. Since the thermistor circuit is connected to the external output connector, the number of poles of the first connector and the second connector need not be increased and a space for the battery wiring module can be saved.

(6) The first flexible printed circuit board may include a first land and the first land may be connected to a side surface of one of the first busbars with soldering. The second flexible printed circuit board may include a second land and the second land may be connected to a side surface of one of the second busbars with soldering.

According to such a configuration, work efficiency in the connection between the first land and the first busbar with soldering and the connection between the second land and the second busbar with soldering is improved.

### Details of Embodiments According to the Present Disclosure

Embodiments according to the present disclosure will be described. The present disclosure is not limited to the embodiments. All modifications within and equivalent to the technical scope of the claimed invention may be included in the technical scope of the present invention.

<First Embodiment>

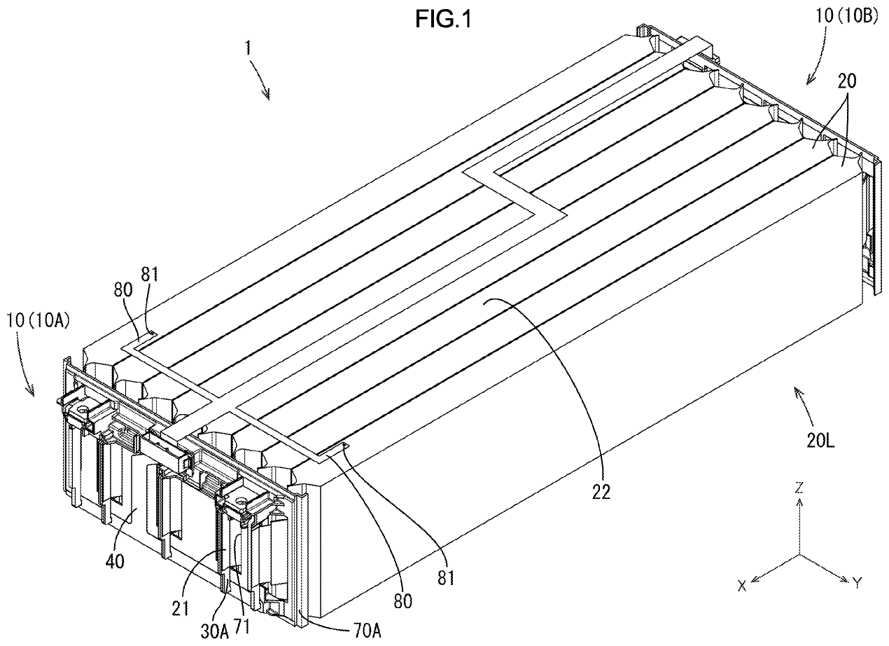

A first embodiment of the present disclosure will be described with reference to FIGS. 1 to 8. A battery module 1 including a battery wiring module 10 according to this embodiment is installed in a vehicle as a power source for driving a vehicle such as an electric automobile or a hybrid automobile. In the following description, it is considered that an Z arrow, an X arrow, and a Y arrow point the upper side, the front side, and the left side, respectively. Regarding components having the same configuration, some of the components may be indicated by reference signs and others may not be indicated by the reference signs.

### Battery Module

As illustrated in FIG. 1, the battery module 1 according to the first embodiment includes multiple battery cells 20L and a battery wiring module 10 that are attached to the battery cells 20L.

### Battery Cell, Electrode Lead

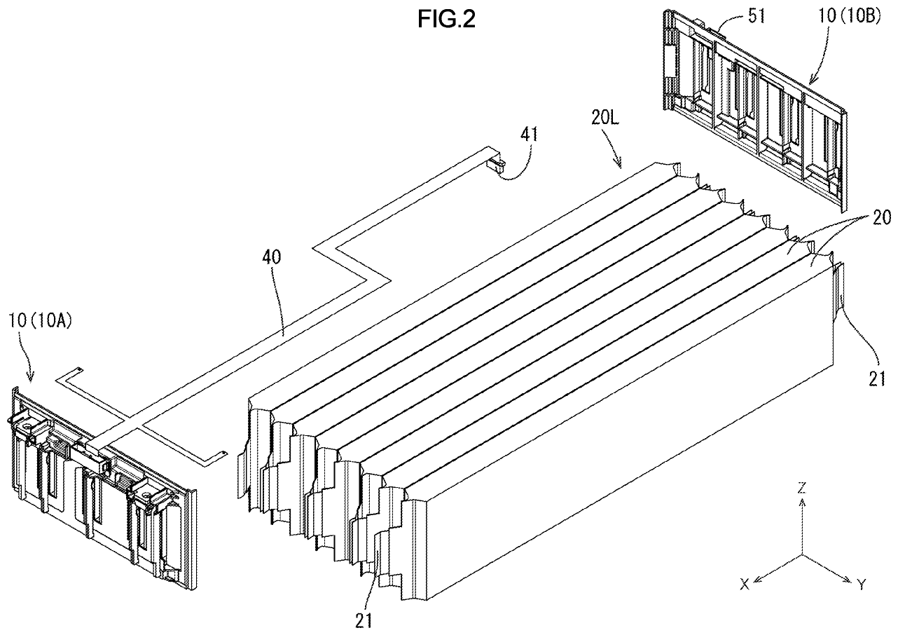

As illustrated in FIG. 2, the multiple battery cells 20L include battery cells 20 that are arranged in a right-left direction. The battery cells 20 have a flat shape that is elongated in a front-rear direction and has a small thickness in the right-left direction. The battery cells 20 include power storage elements (not illustrated) therein. The battery cell 20 includes two electrode leads 21. The two electrode leads 21 are on front and rear sides of the battery cell 20, respectively, and protrude from the battery cell 20 in opposite directions. The two electrode leads 21 have a plate shape and have opposite polarities. Namely, one of the electrode leads 21 on one side of the battery cell 20 with respect to the front-rear direction has a negative polarity and other one of the electrode leads 21 has a positive polarity.

In this embodiment, the battery cell 20 is a secondary battery such as a lithium-ion secondary battery.

As illustrated in FIG. 2, the multiple battery cells 20L include the electrode leads 21 protruding frontward from the respective battery cells 20 and the electrode leads 21 protruding rearward from the respective battery cells 20. As will be described later, in this embodiment, two battery wiring modules 10 are attached to the multiple battery cells 20L on the front side and the rear side, respectively, to electrically connect the electrode leads 21 of the respective battery cells 20 on each of the front side and the rear side. The electrode leads 21 of the multiple battery cells 20L are bent as appropriate and cut into a required length for connection to the battery wiring module 10.

As illustrated in FIGS. 1 and 2, one of the battery wiring modules 10 attached to the multiple battery cells 20L on the front side is defined as a first busbar module 10A and other one of the battery wiring modules 10 attached to the multiple battery cells 20L on the rear side is defined as a second busbar module 10B.

### First Busbar Module

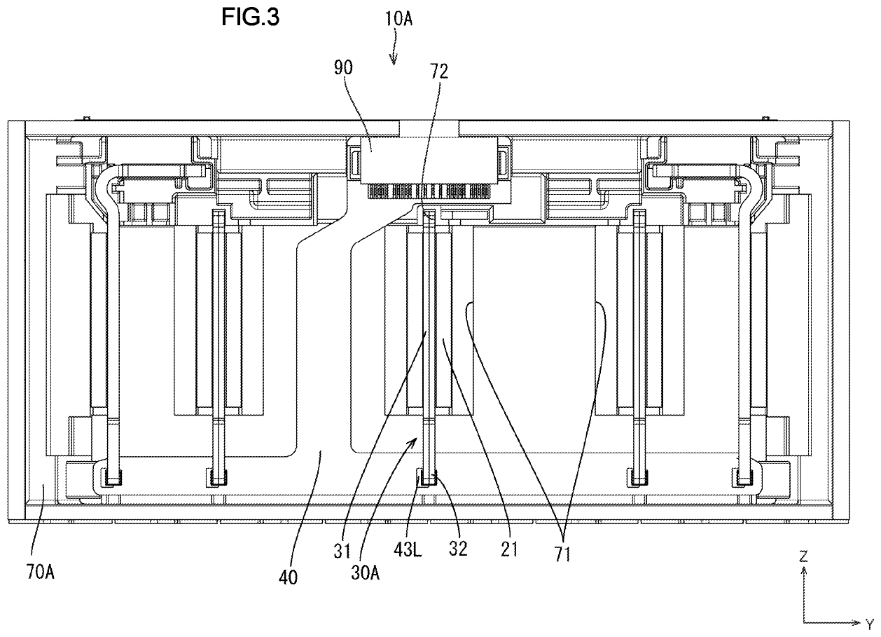

As illustrated in FIG. 3, the first busbar module 10A includes first busbars 30A that are connected to the electrode leads 21 protruding frontward, a first flexible printed circuit board 40 (hereinafter, a flexible printed circuit board is described as an FPC) that is connected to the first busbars 30A, and a first protector 70A that holds the first busbars 30A and the first FPC 40. The first busbars 30A that are disposed on a left edge section and a right edge section of the first busbar module 10A function as electrode terminals of the battery module 1.

### Second Busbar Module

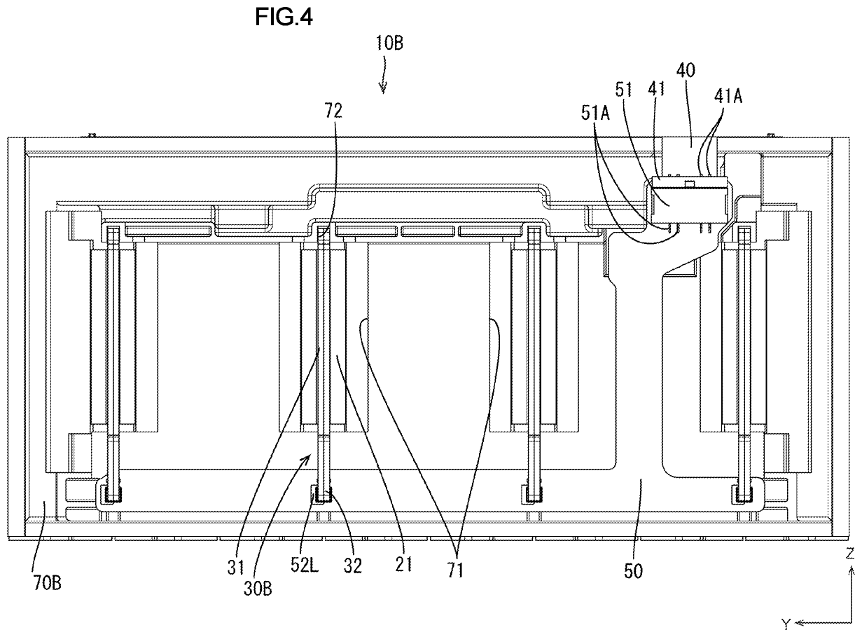

As illustrated in FIG. 4, the second busbar module 10B includes second busbars 30B that are connected to the electrode leads 21 protruding rearward, a second FPC 50 that is connected to the second busbars 30B, and a second protector 70B that holds the second busbars 30B and the second FPC 50.

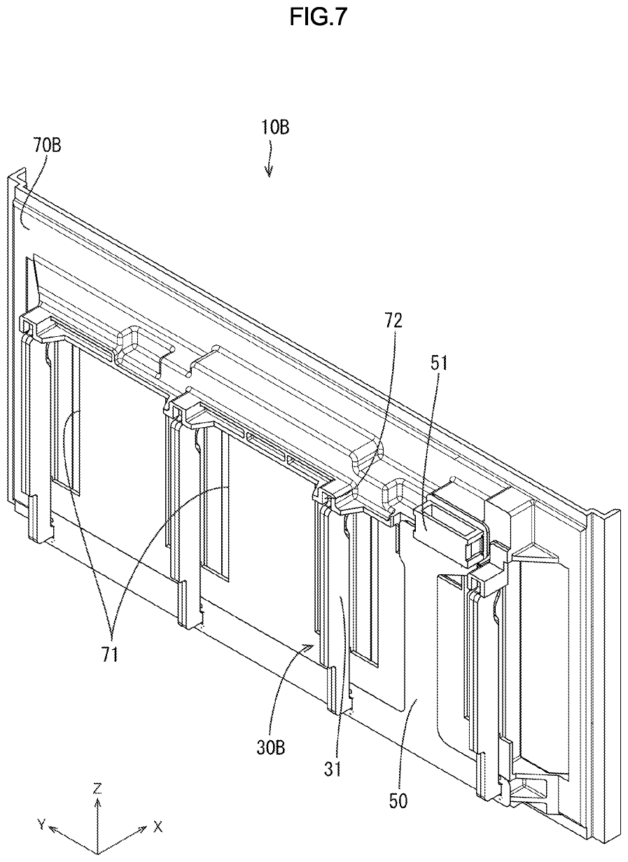

As illustrated in FIG. 2, a first connector 41 is coupled to a rear end of the first FPC 40. As illustrated in FIG. 7, a second connector 51 is disposed on an upper end section of the second FPC 50. As illustrated in FIG. 4, the first connector 41 is detachably fitted to the second connector 51. With such a configuration, the two battery wiring modules 10 can be separated from each other.

### First Protector, Second Protector

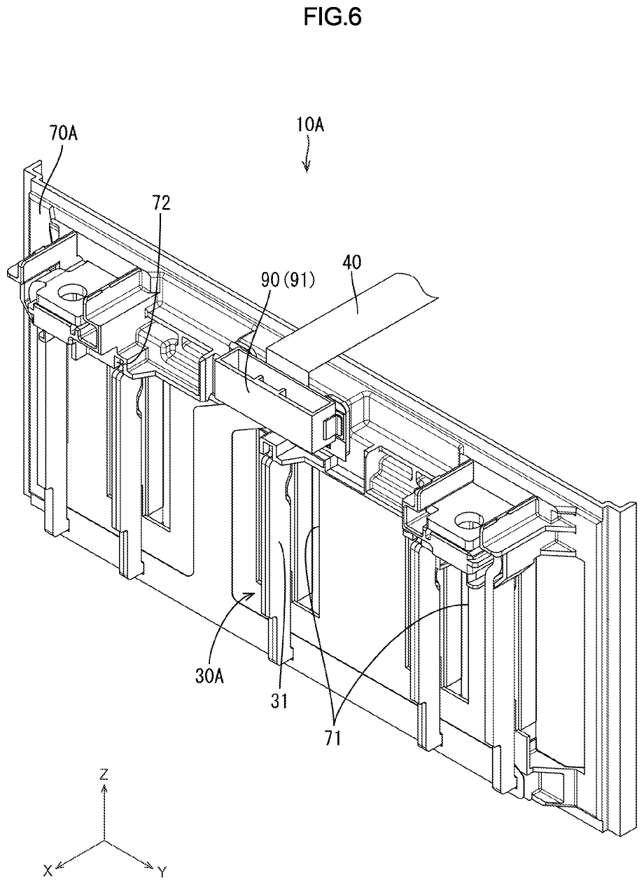

The first protector 70A is made of synthetic resin having insulating properties and has a plate shape as illustrated in FIG. 6. The first protector 70A includes electrode receiving portions 71 in a middle with respect to the upper-bottom direction. The electrode receiving portions 71 are arranged in the right-left direction and are through in the front-rear direction and have a rectangular shape that is elongated in the upper-bottom direction. The first protector 70A includes groove portions 72 on an upper section of the first protector 70A and the groove portions 72 are for holding the first busbars 30A. As illustrated in FIG. 7, the second protector 70B also includes the electrode receiving portions 71 and the groove portions 72 similarly to the first protector 70A.

### First Busbar, Second Busbar

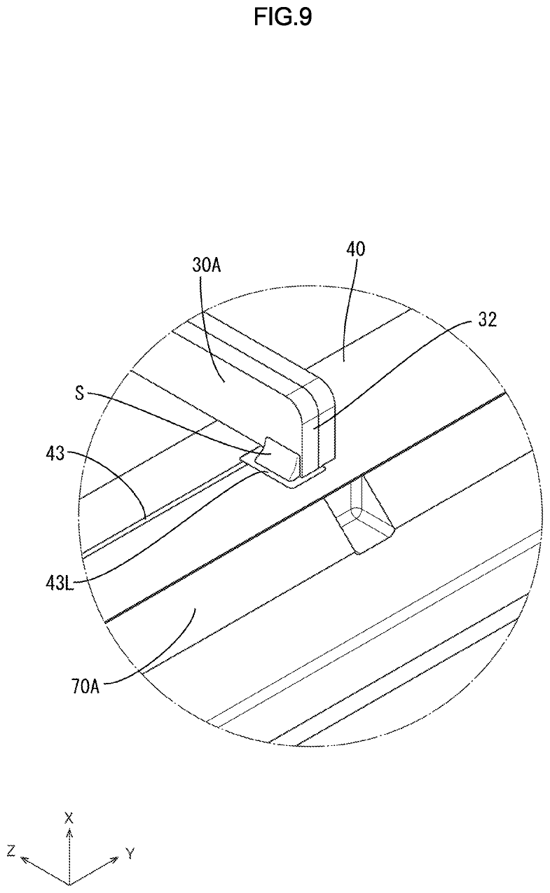

The first busbar 30A and the second busbar 30B have a plate shape and are made by processing a metal plate having electrically conductive properties. As illustrated in FIGS. 3 and 6, the first busbar 30A is held in the groove portion 72 that is in the upper section of the first protector 70A such that a thickness direction of the first busbar 30A corresponds to the right-left direction. As illustrated in FIG. 3, the first busbar 30A includes a connection portion 32 in a lower section thereof. As illustrated in FIG. 9, the connection portion 32 is electrically connected to a first land 43L, which will be described later, of the first FPC 40 with soldering. As illustrated in FIG. 6, the first busbar 30A includes a body portion 31 in a middle of the first busbar 30A and the electrode lead 21 is connected to the body portion 31. As illustrated in FIG. 3, when the first busbar module 10A is attached to a front section of the multiple battery cells 20L, the electrode leads 21 protruding frontward are inserted in the electrode receiving portions 71 of the first protector 70A, respectively, and the body portions 31 are connected to the respective electrode leads 21, which are inserted in the electrode receiving portions 71, with laser welding. As illustrated in FIG. 4, the second busbars 30B are held in the groove portions 72 of the second protector 70B, respectively, and the connection portions 32 of the second busbars 30B are electrically connected to the second lands 52L of the second FPC 50 with laser welding.

### First FPC, Second FPC

The first FPC 40 includes a base film 42A, first conductive lines 43 and second conductive lines 44 that are mounted on one surface of the base film 42A, and a coverlay film 42B that covers the first conductive lines 43 and the second conductive lines 44. The base film 42A and the coverlay film 42B are made of synthetic resin such as polyimide that is flexible and has insulating properties. The first conductive lines 43 and the second conductive lines 44 are made of a metal foil such as a copper foil and a copper alloy foil. The first conductive lines 43 and the second conductive lines 44 may be connected to any electronic components such as a resistance, a capacitor, and a transistor. The coverlay film 42B has a hole through which ends of the first conductive lines 43 and the second conductive lines 44 are exposed. The first conductive lines 43 and the second conductive lines 44 can be electrically connected to a component with soldering at the exposed ends of the first conductive lines 43 and the second conductive lines 44. The first conductive lines 43 and the second conductive lines 44 are electrically connected to an electronic control unit (ECU) which is an external device and not illustrated. The ECU has a known configuration including a microcomputer and components and has a function of detecting a voltage, a current, and a temperature of the battery cell 20 and has a function of controlling charging and discharging of each battery cell. Similarly to the first FPC 40, the second FPC 50 includes a base film, third conductive lines that are mounted on one surface of the base film, and a coverlay film that covers the third conductive lines, although the specific configuration of the second FPC 50 is not illustrated. As will be described later, the third conductive lines are electrically connected to the second conductive lines 44.

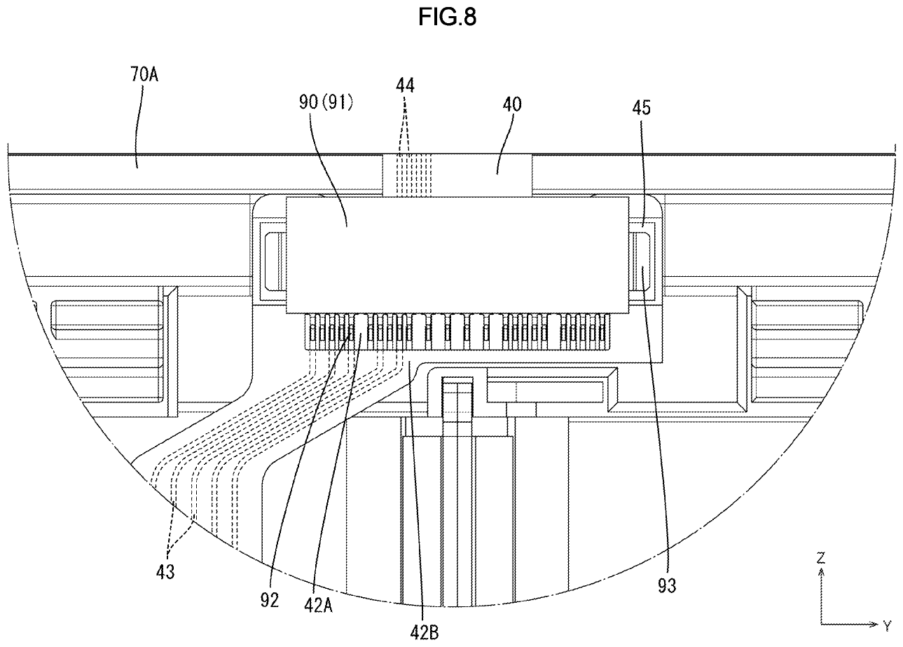

As illustrated in FIG. 3, the first FPC 40 has a plan view T-shape that is reversed upside down. The first FPC 40 is fixed to the first protector 70A with adhesive. An external output connector 90 is mounted on an upper edge section of a portion of the first FPC 40 that is fixed to the first protector 70A. As illustrated in FIG. 8, the external output connector 90 is disposed on a front side of the base film 42A. As illustrated in FIG. 6, the first FPC 40 is bent at an upper edge of the first protector 70A and extends rearward. As illustrated in FIG. 1, a portion of the first FPC 40 extending in the front-rear direction is mounted on an upper outer surface 22 of the multiple battery cells 20L. As illustrated in FIG. 2, the first FPC 40 includes the first connector 41 at the rear end thereof. The first connector 41 has a block shape. The first connector 41 is inserted in the second connector 51 and fitted to the second connector 51.

As illustrated in FIG. 8, in a fixed portion of the first FPC 40 that is fixed to the front surface of the first protector 70A, the first conductive lines 43 are mounted on a section of the fixed portion lower than the external output connector 90. Upper ends of the first conductive lines 43 are electrically connected to connection portions 92 of the external output connector 90 with soldering. The first conductive lines 43 extend downward from the connection portions 92. As illustrated in FIG. 3, first lands 43L are disposed at other ends of the first conductive lines 43, respectively. The first land 43L is made of a metal foil similar to that of the first conductive lines 43 and has a rectangular shape. The first lands 43L are arranged in the right-left direction in a lower section of the first FPC 40. As illustrated in FIG. 9, the first land 43L is on a right side of the connection portion 32 of the first busbar 30A and is electrically connected to a right surface of the connection portion 32 of the first busbar 30A with the solder S. With the first land 43L being connected to one side surface of the connection portion 32 of the first busbar 30A with soldering, an operation of soldering can be performed efficiently with using a general soldering iron.

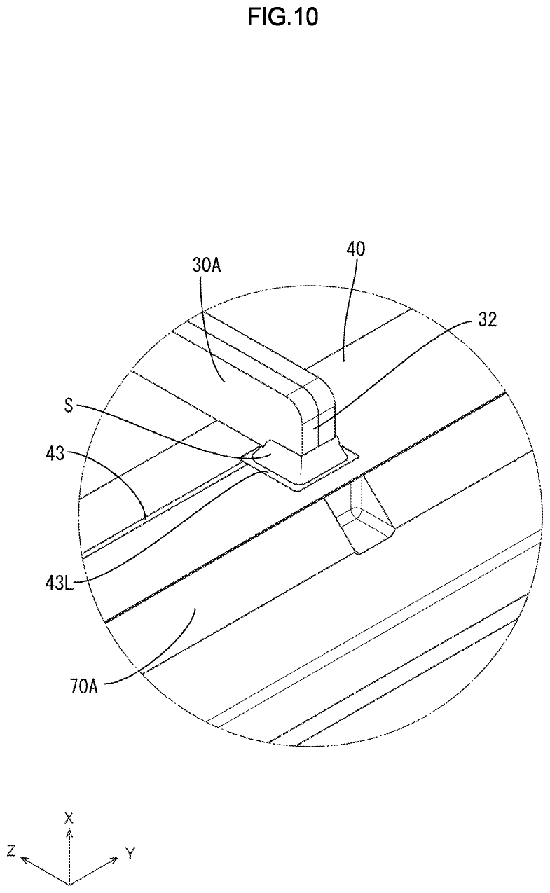

The first land 43L may be disposed on right and left sides of the connection portion 32 of the first busbar 30A or around the connection portion 32. The first busbar 30A may be connected to the first FPC 40 with multiple side surfaces of the connection portion 32 with soldering. For example, as illustrated in FIG. 10, the first land 32L may be disposed on a peripheral portion around the connection portion 32 of the first busbar 30A and the first busbar 30A may be connected to the first FPC 40 with four side surfaces of the connection portion 32 with the solder S. In such a configuration, since a connection area using the solder S becomes large, the first busbar 30A can be stably connected to the first FPC 40. However, this may deteriorate work efficiency since the soldering needs to be performed on an increased number of side surfaces of the connection portion 32 of the first busbar 30A. With using a special soldering iron that is formed to fit to the shape of the connection portion 32 of the first busbar 30A, the work efficiency can be improved.

In the fixed portion of the first FPC 40 that is fixed to the front surface of the first protector 70A, ends of the second conductive lines 44 are electrically connected to the connection portions 92 of the external output connector 90 similar to the ends of the first conductive lines 43. As illustrated in FIG. 8, the second conductive lines 44 extend upward from the connection portions 92. Namely, the second conductive lines 44 extend upward on a portion of the base film 42A on which the external output connector 90 is mounted. The second conductive lines 44 are bent at the upper edge of the first protector 70A and extend rearward. As illustrated in FIG. 4, rear ends of the second conductive lines 44 are electrically connected to connection portions 41A of the first connector 41 with soldering. The first connector 41 is fitted to the second connector 51 (refer to FIG. 7), which is held by the second protector 70B, from the above. The first FPC 40 including the second conductive lines 44 are bent downward at an upper edge of the second protector 70B.

### Thermistor Circuit

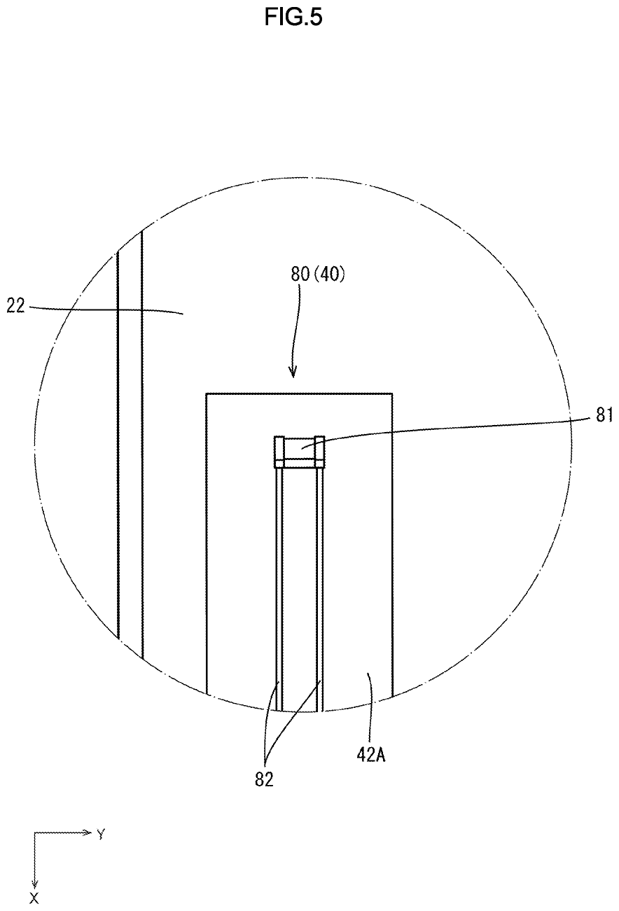

As illustrated in FIG. 1, the first FPC 40 integrally includes thermistor circuits 80. As illustrated in FIG. 5, the thermistor circuit 80 includes a thermistor 81 and thermistor conductive lines 82 and is mounted on the base film 42A. The thermistor 81 is connected to the connection portions 92 of the external output connector 90 via the thermistor conductive lines 82. As illustrated in FIG. 1, two thermistors 81 are disposed on the first FPC 40. The thermistors 81 are mounted on the upper outer surface 22 of the multiple battery cells 20L. The ECU receives outputs from the thermistors 81 to detect the temperature of the multiple battery cells 20L.

### External Output Connector

As illustrated in FIG. 6, the external output connector 90 includes a housing 91 and terminals (not illustrated) that are disposed in the housing 91. The housing 91 is a square box that is elongated in the right-left direction. The housing 91 opens upward and is configured to receive a target connector (not illustrated) that is a target object to be fitted to the external output connector 90. The target connector is mounted on an end of the ECU. By fitting the target connector to the external output connector 90, each of the battery cells 20 is electrically connected to the ECU. As illustrated in FIG. 8, end sections of the terminals that are arranged in the housing 91 extend below the external output connector 90 and are configured as the connection portions 92. The connection portions 92 are electrically connected to the ends of the first conductive lines 43 and the ends of the second conductive lines 44 with soldering. Fixing portions 93 that are made of metal are attached to right and left side surfaces of the housing 91, respectively. The external output connector 90 is fixed to the base film 42A by fixing the fixing portions 93 to fixing lands 45 disposed on the base film 42A with soldering.

As illustrated in FIG. 4, the second FPC 50 has a T-shape that is reversed upside down and includes a vertical portion, which extends in the upper-bottom direction, on a right side with respect to a middle section. The second FPC 50 is fixed to the second protector 70B with adhesive. The second connector 51 is disposed on the upper end section of the second FPC 50. As illustrated in FIG. 7, the second connector 51 opens upward. As illustrated in FIG. 4, connection portions 51A that are disposed below the second connector 51 are electrically connected to upper ends of the third conductive lines (not illustrate). The third conductive lines extend downward from the connection portions 51A. The second lands 52L are formed at lower ends of the third conductive lines. The second lands 52L are arranged in the right-left direction in a lower edge section of the second FPC 50 and are electrically connected to the connection portions 32 of the second busbars 30B, respectively. The connection portions 32 of the second busbars 30B are connected to the second lands 52L similarly to the connection of the connection portions 32 of the first busbars 30A and the first lands 43L (refer to FIG. 9). By inserting the first connector 41 into the second connector 51, the first connector 41 is fitted to the second connector 51 and the third conductive lines are connected to the second conductive lines 44. Accordingly, the second busbar 30B is connected to the external output connector 90.

### Mounting of Battery Wiring Module on Multiple Battery Cells

As illustrated in FIG. 1, the first busbar module 10A is attached to the front section of the multiple battery cells 20L. The electrode leads 21 protruding frontward are inserted in the electrode receiving portions 71 and the electrode leads 21 and the first busbar 30A are joined with laser welding. A portion of the first FPC 40 that extends rearward from the upper edge of the first protector 70A and the thermistor circuits 80 are disposed on the upper outer surface 22 of the multiple battery cells 20L. The second busbar module 10B is attached to the rear section of the multiple battery cells 20L similarly to the first bus module 10A.

Next, as illustrated in FIG. 4, by fitting the first connector 41 to the second connector 51, the external output connector 90 is electrically connected to the second busbar 30B. Accordingly, the ECU can receive electric signals from the battery cells 20 and perform a control. Thus, the mounting of the battery wiring module 10 on the multiple battery cells 20L is completed (refer to FIG. 1).

### Operations and Effects of First Embodiment

According to the first embodiment, operations and effects described below are obtained.

The battery wiring module 10 according to the first embodiment is to be mounted on the multiple battery cells 20L to electrically connect the multiple battery cells 20L. The multiple battery cells 20L are long in the front-rear direction and include the electrode leads 21 on the front and rear ends thereof. The battery wiring module 10 includes the first busbar module 10A that is to be attached to the front section of the multiple battery cells 20L and the second busbar module 10B that is a separate component from the first busbar module 10A and to be attached to the rear section of the multiple battery cells 20L. The first busbar module 10A includes the first busbars 30A, the first FPC 40 that is connected to the first busbars 30A, and the first protector 70A that holds the first busbars 30A and the first FPC 40. The first busbars 30A are to be connected to the electrode leads 21 that protrude frontward from the multiple battery cells 20L. The second busbar module 10B includes the second busbars 30B, the second FPC 50 that is connected to the second busbars 30B, and the second protector 70B that holds the second busbars 30B and the second FPC 50. The second busbars 30B are to be connected to the electrode leads 21 that protrude rearward from the multiple battery cells 20L. The first FPC 40 and the second FPC 50 are electrically connected to each other with the first busbar module 10A and the second busbar module 10B being attached to the multiple battery cells 20L.

According to the above configuration, since the first busbar module 10A and the second busbar module 10B are separate components, the first busbar module 10A and the second busbar module 10B can be attached to the multiple battery cells 20L separately. This improves workability in the assembling process of the battery wiring module 10.

In the first embodiment, the first FPC 40 includes the first connector 41 and the second FPC 50 includes the second connector 51 that is to be fitted to the first connector 41 to electrically connect the first FPC 40 and the second FPC 50.

According to the above configuration, by fitting the first connector 41 to the second connector 51 after attaching the first busbar module 10A and the second busbar module 10B separately to the multiple battery cells 20L, the first busbar module 10A and the second busbar module 10B are electrically connected to each other.

In the first embodiment, the first FPC 40 further includes the external output connector 90. The second connector 51 is disposed on the second protector 70B and the external output connector 90 is disposed on the first protector 70A.

According to the above configuration, with the external output connector 90 being disposed on the first protector 70A and the second connector 51 being disposed on the second protector 70B, a space for the battery wiring module 10 can be saved.

In the first embodiment, the thermistor circuits 80 are integrally mounted on the first FPC 40 and the thermistor circuits 80 are electrically connected to the external output connector 90.

According to the above configuration, with the thermistor circuits 80, the temperature of the multiple battery cells 20L can be detected. Since the thermistor circuits 80 are connected to the external output connector 90, the number of poles of the first connector 41 and the second connector 51 need not be increased and a space for the battery wiring module 10 can be saved.

In the first embodiment, the first FPC 40 includes the first land 43L that is to be connected to one side surface of the first busbar 30A with soldering. The second FPC 50 includes the second land 52L that is to be connected to one side surface of the second busbar 30B with soldering.

According to the above configuration, work efficiency in the connection between the first land 43L and the first busbar 40A with soldering and the connection between the second land 52L and the second busbar 30B with soldering is improved.

<Second Embodiment>

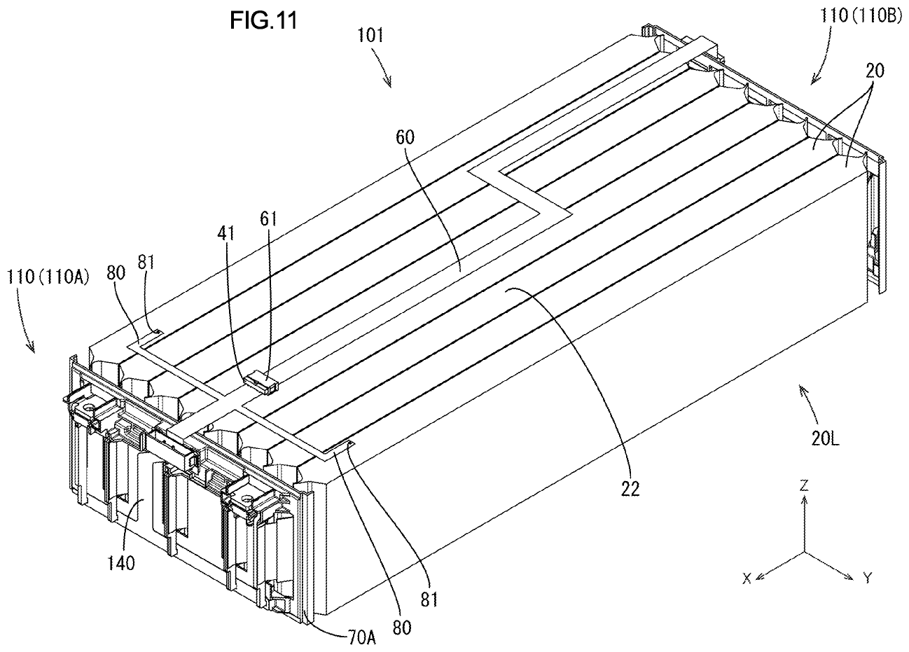

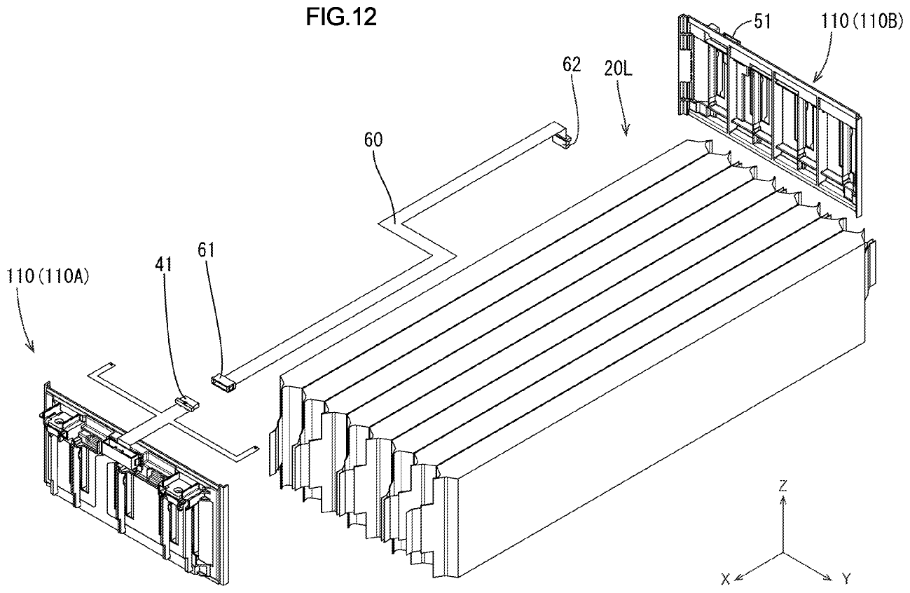

A second embodiment of the present disclosure will be described with reference to FIGS. 11 and 12. In the following description, components having the same configurations as those of the first embodiment and operations and effects same as those of the first embodiment will not be described. The Z arrow, the X arrow, and the Y arrow point the upper side, the front side, and the left side, respectively. Regarding components having the same configuration, some of the components may be indicated by reference signs and others may not be indicated by the reference signs.

As illustrated in FIG. 11, a battery module 101 according to the second embodiment includes the multiple battery cells 20L and a battery wiring module 110 that is mounted on the multiple battery cells 20L. The battery wiring module 110 includes a first busbar module 110A and a second busbar module 110B. The first busbar module 110A is attached to the front section of the multiple battery cells 20L and the second busbar module 110B is attached to the rear section of the multiple battery cells 20L similarly to the first busbar module 10A and the second busbar module 10B of the first embodiment. The first busbar module 110A includes a first FPC 140. The first FPC 140 includes a portion that extends rearward from the upper edge of the first protector 70A. The portion of the first FPC 140 is shorter than a portion of the first FPC 40 of the first embodiment extending rearward from the upper edge of the first protector 70A. The battery wiring module 110 includes an intermediate line 60 that is provided separately from the first busbar module 110A and the second busbar module 110B. The intermediate line 60 is disposed on the upper outer surface 22 of the multiple battery cells 20L and extends in the front-rear direction. As will be described later, the intermediate line 60 electrically connects the first busbar module 110A and the second busbar module 110B. Namely, the battery wiring module 10 of the first embodiment has a structure divided into two parts (refer to FIG. 2) and the battery wiring module 110 of this embodiment has a structure divided into three parts (refer to FIG. 12). In the following, the intermediate line 60 will be described.

### Intermediate Line, Third Connector, Fourth Connector

In this embodiment, a FPC is used as the intermediate line 60. Although details are not illustrated, the intermediate line 60 includes a base film, fourth conductive lines that are mounted on one surface of the base film, and a coverlay film that covers the fourth conductive lines. As illustrated in FIG. 12, a third connector 61 is electrically connected to front ends of the fourth conductive lines with soldering. The third connector 61 has a shape of a rectangular parallelepiped that opens frontward and receives the first connector 41. A fourth connector 62 is electrically connected to rear ends of the fourth conductive lines with soldering. The fourth connector 62 has a block shape and is to be inserted in the second connector 51. Since the second connector 51 opens upward, the intermediate line 60 is bent downward in a rear end portion such that the fourth connector 62 can be inserted in the second connector 51 from the above. A rear view of the battery module 101 in which the second connector 51 and the fourth connector 62 are fitted to each other is not illustrated but is similar to that of the first embodiment illustrated in FIG. 4.

In mounting the battery wiring module 110 on the multiple battery cells 20L, similar to the first embodiment, the first busbar module 110A and the second busbar module 110B are attached to the multiple battery cells 20L. Next, the intermediate line 60 is disposed on the upper outer surface 22 of the multiple battery cells 20L. The third connector 61 of the intermediate line 60 is fitted to the first connector 41 of the first busbar module 110A and the fourth connector 62 of the intermediate line 60 is fitted to the second connector 51 of the second busbar module 110B. Accordingly, the external output connector 90 is electrically connected to each of the battery cells 20. Thus, the mounting of the battery wiring module 110 on the multiple buttery cells 20L is completed (refer to FIG. 11).

### Operations and Effects of Second Embodiment

According to the second embodiment, operations and effects described below are obtained.

The second embodiment includes the intermediate line 60 that electrically connects the first FPC 140 and the second FPC 50. The first FPC 140 includes the first connector 41 and the second FPC 50 includes the second connector 51. The intermediate line 60 includes the third connector 61 that is to be fitted to the first connector 41 and the fourth connector 62 that is to be fitted to the second connector 51.

According to such a configuration, the intermediate line 60 is provided to electrically connect the first busbar module 110A and the second busbar module 110B. This reduces lengths of the first FPC 140 and the second FPC 50 and improves handling of the first busbar module 110A and the second busbar module 110B.

<Other Embodiments>

(1) In the first embodiment, between the first FPC 40 and the second FPC 50, only the first FPC 40 extends in the front-rear direction; however, the FPCs do not necessarily have such a configuration. For example, between the first FPC and the second FPC, only the second FPC may extend in the front-rear direction or the first FPC and the second FPC may extend in the front-rear direction and have an about same length.

(2) In the above embodiments, the battery wiring modules 10, 110 include the thermistor circuits 80; however, they do not necessarily have such a configuration. The battery wiring module may not include a thermistor circuit.

(3) In the second embodiment, the flexible printed circuit board (FPC) is used as the intermediate line 60; however, the intermediate line 60 may not be limited to the FPC. A flexible flat cable (FFC) or wires may be used as the intermediate line.

### EXPLANATION OF SYMBOLS

1, 101: Battery module

10, 110: Battery wiring module

10A, 110A: First busbar module

10B, 110B: Second busbar module

20: Battery cell

20L: Multiple battery cells

21: Electrode lead

22: Upper outer surface

30A: First busbar

30B: Second busbar

31: Body portion

32: Connection portion

40, 140: First FPC

41: First connector

41A: Connection portion

42A: Base film

42B: Coverlay film

43: First conductive line

43L: First land

44: Second conductive line

45: Fixing land

50: Second FPC

51: Second connector

51A: Connection portion

52L: Second land

60: Intermediate line

61: Third connector

62: Fourth connector

70A: First protector

70B: Second protector

71: Electrode receiving portion

72: Groove portion

80: Thermistor circuit

81: Thermistor

82: Thermistor conductive line

90: External output connector

91: Housing

92: Connection portion

93: Fixing portion

S: Soldering

1. A battery wiring module that is to be attached to multiple battery cells being long in a front-rear direction and including electrode leads at front ends and rear ends of the multiple battery cells to electrically connect the multiple battery cells, the battery wiring module comprising:
a first busbar module to be attached to a front section of the multiple battery cells; and
a second busbar module that is a separate component from the first busbar module and to be attached to a rear section of the multiple battery cells, wherein
the first busbar module includes first busbars that are to be connected to the electrode leads protruding frontward from the multiple battery cells, a first flexible printed circuit board that is to be connected to the first busbars, and a first protector that holds the first busbars and the first flexible printed circuit board,
the second busbar module includes second busbars that are to be connected to the electrode leads protruding rearward from the multiple battery cells, a second flexible printed circuit board that is connected to the second busbars, and a second protector that holds the second busbars and the second flexible printed circuit board, and
the first flexible printed circuit board and the second flexible printed circuit board are electrically connectable to each other with the first busbar module and the second busbar module being attached to the multiple battery cells.

2. The battery wiring module according to claim 1, wherein
the first flexible printed circuit board includes a first connector, and
the second flexible printed circuit board includes a second connector that is fitted to the first connector to electrically connect the first flexible printed circuit board and the second flexible printed circuit board.

3. The battery wiring module according to claim 2, wherein
the first flexible printed circuit board further includes an external output connector,
the second connector is disposed on the second protector, and
the external output connector is disposed on the first protector.

4. The battery wiring module according to claim 1 further comprising an intermediate line that electrically connects the first flexible printed circuit board and the second flexible printed circuit board, wherein
the first flexible printed circuit board includes a first connector,
the second flexible printed circuit board includes a second connector, and
the intermediate line includes a third connector that is fitted to the first connector and a fourth connector that is fitted to the second connector.

5. The battery wiring module according to claim 3, wherein
a thermistor circuit is integrally disposed on the first flexible printed circuit board, and
the thermistor circuit is electrically connected to the external output connector.

6. The battery wiring module according to claim 1, wherein
the first flexible printed circuit board includes a first land,
the first land is connected to a side surface of one of the first busbars with soldering,
the second flexible printed circuit board includes a second land, and
the second land is connected to a side surface of one of the second busbars with soldering.

7. The battery wiring module according to claim 2, wherein
the first flexible printed circuit board includes a first land,
the first land is connected to a side surface of one of the first busbars with soldering,
the second flexible printed circuit board includes a second land, and
the second land is connected to a side surface of one of the second busbars with soldering.

8. The battery wiring module according to claim 3, wherein
the first flexible printed circuit board includes a first land,
the first land is connected to a side surface of one of the first busbars with soldering,
the second flexible printed circuit board includes a second land, and
the second land is connected to a side surface of one of the second busbars with soldering.

9. The battery wiring module according to claim 4, wherein
the first flexible printed circuit board includes a first land,
the first land is connected to a side surface of one of the first busbars with soldering,
the second flexible printed circuit board includes a second land, and
the second land is connected to a side surface of one of the second busbars with soldering.

10. The battery wiring module according to claim 5, wherein
the first flexible printed circuit board includes a first land,
the first land is connected to a side surface of one of the first busbars with soldering,
the second flexible printed circuit board includes a second land, and
the second land is connected to a side surface of one of the second busbars with soldering.
